(19) United States
(12) Patent Application Publication
(10) Pub. No.: US 2026/0080246 A1
(43) Pub. Date: Mar. 19, 2026

(54) MODEL TRAINING METHOD, CONSTRUCTION SAFETY EVALUATION METHOD, APPARATUS, AND DEVICE

(71) Applicant: Three Gorges Hi-Tech Information Technology Co., Ltd, Wuhan (CN)

(72) Inventors: Chen ZHANG, Wuhan (CN); Yunpeng CHEN, Wuhan (CN); Qinglin WANG, Wuhan (CN); Jiandong WANG, Wuhan (CN); Lingling ZHANG, Wuhan (CN); Changhao CHEN, Wuhan (CN); Yaying YU, Wuhan (CN); Ningxi LI, Wuhan (CN)

(73) Assignee: Three Gorges Hi-Tech Information Technology Co., Ltd, Wuhan (CN)

(21) Appl. No.: 19/342,255

(22) Filed: Sep. 26, 2025

Related U.S. Application Data
(63) Continuation of application No. PCT/CN2025/115098, filed on Aug. 15, 2025.

(30) Foreign Application Priority Data
Sep. 18, 2024 (CN) 202411296300.9

(51) Int. Cl. G06Q 50/26; G06N 3/08; G06Q 50/08

(52) U.S. Cl. CPC G06N 3/08; G06Q 50/265

(57) ABSTRACT

A model training method includes: obtaining sample data; determining a tag missing ratio of the training sample in different dimensions and a first weight value of the training sample in different dimensions according to association information between a training sample and a true value tag; determining a second weight value of the training sample according to the tag missing ratio; and inputting the sample data, the first weight value, and the second weight value into a preset neural network model for training, until a loss value of a target loss function of the preset neural network model meets a model convergence condition to obtain a target prediction model.

### CROSS-REFERENCE TO RELATED APPLICATIONS

This application is a continuation of International Application No. PCT/CN2025/115098, filed on Aug. 15, 2025, which claims priority to Chinese Patent Application No. 202411296300.9, filed on Sep. 18, 2024. The disclosures of the above-mentioned applications are hereby incorporated by reference in their entireties.

### TECHNICAL FIELD

The present disclosure relates to the field of computer technologies, and in particular, to a model training method, a construction safety evaluation method, an apparatus, and a device.

### BACKGROUND

In practical application, due to factors such as device failure and data acquisition errors, a data set often misses data to varying degrees. Usually, a deep neural network model is trained by deleting samples with missing values or using a mean value and a median value to perform interpolation training, but complexity and diversity of missing data are not fully considered, so that the data set introduces errors due to loss of authenticity and loss of some information, thereby affecting the prediction accuracy of the model and resulting in a problem of an unsatisfactory prediction effect.

### SUMMARY

In view of this, the present disclosure provides a model training method, a construction safety evaluation method, an apparatus, and a device. In a manner of improving a weighted loss function, the sample data in which some tags are missing is retained, which solves the problem that the data set in which some tags are missing affects the prediction accuracy of the model.

According to a first aspect of the present disclosure, there is provided a model training method, including:
obtaining sample data, where the sample data includes a training sample and a true value tag of the training sample in different dimensions;
determining a tag missing ratio of the training sample in different dimensions and a first weight value of the training sample in different dimensions according to association information between the training sample and the true value tag;
determining a second weight value of the training sample according to the tag missing ratio; and
inputting the sample data, the first weight value, and the second weight value into a preset neural network model for training, until a loss value of a target loss function of the preset neural network model meets a model convergence condition to obtain a target prediction model.

Preferably, determining a first weight value of the training sample in different dimensions according to association information between the training sample and the true value tag includes:
if the association information is that the training sample is associated with the true value tag in any dimension, assigning a value of 1 to the first weight value in any dimension; and
if the association information is that the training sample is not associated with the true value tag in any dimension, assigning a value of 0 to the first weight value in any dimension.

Preferably, determining a tag missing ratio of the training sample in different dimensions according to association information between the training sample and the true value tag includes:
counting the number of missing tags of the training sample in which the association information is that the training sample is not associated with the true value tag in any dimension; and
calculating the quotient of the number of missing tags in the dimension and the total number of training samples in the sample data as the tag missing ratio in any dimension.

Preferably, determining a second weight value of the training sample according to the tag missing ratio includes:
calculating an information entropy and mutual information of the true value tag; and
determining the second weight value according to the information entropy, the mutual information, and the tag missing ratio.

Preferably, the formula for calculating the information entropy of the true value tag is expressed as:

$${E}_{j} = - {\sum }_{i = 1}^{n} {p}_{ij} {log}_{2} {p}_{ij} ;$$

where Eⱼ denotes the information entropy of the j-th true value tag, pᵢⱼ denotes the probability that the value of the i-th training sample appears on the j-th true value tag, and n denotes the total number of training samples.

Preferably, the formula for calculating the mutual information of the true value tag is expressed as:

$$I ( {Y}_{j} ; {Y}_{k} ) = {\sum }_{i = 1}^{n} {\sum }_{{y}_{j} , {y}_{k}} p ( {y}_{j} , {y}_{k} ) {log}_{2} \frac{p ( {y}_{j} , {y}_{k} )}{p ( {y}_{j} ) p ( {y}_{k} )} ;$$

where I(Yⱼ;Yₖ) denotes the mutual information between tags Yⱼ and Yₖ, p(yⱼ,yₖ) denotes a joint probability quality function of tags Yⱼ and Yₖ, and p(yⱼ) and p(yₖ) denote marginal probability quality functions of tags Yⱼ and Yₖ, respectively.

The second weight value is determined according to the information entropy, the mutual information, and the tag missing ratio using the following formula:

$${w}_{j} = \frac{1 - {E}_{j}}{{\sum }_{k - 1}^{m} ( 1 - {E}_{k} )} \times \frac{{\sum }_{k - 1}^{m} I ( {Y}_{j} ; {Y}_{k} )}{max {\sum }_{l - 1}^{m} I ( {Y}_{k} ; {Y}_{l} )} \times ( 1 - α ) ;$$

where wⱼ denotes a second weight value of the j-th truth value tag, m denotes the total number of truth value tags in any dimension, Eⱼ denotes the information entropy of the j-th truth value tag, I(Yⱼ;Yₖ) denotes the mutual information between tags Yⱼ and Yₖ, I(Yₖ;Yₗ) denotes the mutual information between tags Yₖ and Yₗ, and α denotes a tag missing ratio in any dimension.

Preferably, the target loss function is expressed as:

$$loss ( y , \hat{y} ) = \frac{1}{n} {\sum }_{i = 1}^{n} {\sum }_{j = 1}^{l} {{w}_{j} [ {a}_{ij} ( {\hat{y}}_{j}^{i} - {y}_{j}^{i} ) ]}^{2} ;$$

where loss denotes a loss function, y denotes a true value tag, ŷ denotes a predicted value output by the model, n denotes the total number of training samples, l denotes the number of predicted tags, i denotes the training sample number, aᵢⱼ denotes a first weight value of the j-th true value tag of the i-th training sample, and wⱼ denotes a second weight value of the j-th true value tag.

Preferably, the model training method further includes:
normalizing the second weight value.

According to a second aspect of the present disclosure, there is provided a construction safety evaluation method for a wind power project, including:
obtaining a target prediction model and safety factor information of a target wind power project, where the target prediction model takes safety factor information and a safety score of a historical wind power project as sample data and is trained by the model training method according to the first aspect;
performing dimensionless processing on the safety factor information according to a preset transformation rule to generate a safety index value;
inputting the safety index value into the target prediction model to obtain a safety score of the target wind power project; and
displaying safety early warning information if the safety score is less than or equal to a score threshold.

According to a third aspect of the present disclosure, there is provided a model training apparatus, including:
an obtaining module, which is configured to obtain sample data, where the sample data includes a training sample and a true value tag of the training sample in different dimensions;
a determining module, which is configured to determine a tag missing ratio of the training sample in different dimensions and a first weight value of the training sample in different dimensions according to association information between the training sample and the true value tag; and determine a second weight value of the training sample according to the tag missing ratio; and
a training module, which is configured to input the sample data, the first weight value, and the second weight value into a preset neural network model for training, until a loss value of a target loss function of the preset neural network model meets a model convergence condition to obtain a target prediction model.

Preferably, the determining module is specifically configured to, if the association information is that the training sample is associated with the true value tag in any dimension, assign a value of 1 to the first weight value in any dimension; and if the association information is that the training sample is not associated with the true value tag in any dimension, assign a value of 0 to the first weight value in any dimension.

Preferably, the determining module is specifically configured to count the number of missing tags of the training sample in which the association information is that the training sample is not associated with the true value tag in any dimension; and calculate the quotient of the number of missing tags in the dimension and the total number of training samples in the sample data as the tag missing ratio in any dimension.

Preferably, the determining module is specifically configured to calculate an information entropy and mutual information of the true value tag; and determine the second weight value according to the information entropy, the mutual information, and the tag missing ratio.

Preferably, the model training apparatus further includes:
a preprocessing module, which is configured to normalize the second weight value.

According to a fourth aspect of the present disclosure, there is provided a construction safety evaluation apparatus for a wind power project, including:
an obtaining module, which is configured to obtain a target prediction model and safety factor information of a target wind power project, where the target prediction model takes safety factor information and a safety score of a historical wind power project as sample data and is trained by the model training method according to the first aspect;
a data processing module, which is configured to perform dimensionless processing on the safety factor information according to a preset transformation rule to generate a safety index value;
an evaluation module, which is configured to input the safety index value into the target prediction model to obtain a safety score of the target wind power project; and
an early warning module, which is configured to display safety early warning information if the safety score is less than or equal to a score threshold.

According to a fifth aspect of the present disclosure, there is provided a readable storage medium, on which a program or an instruction is stored. The program or the instruction, when executed by a processor, implements the steps of the model training method and the construction safety evaluation method for the wind power project.

According to a sixth aspect of the present disclosure, there is provided a computer device, including a storage medium, a processor, and a computer program stored on the storage medium and executable on the processor. The processor, when executing the program, implements the steps of the model training method and the construction safety evaluation method for the wind power project.

According to the foregoing technical solution, the weight of the training sample in different dimensions is calculated based on the association information indicating whether the training sample is associated with the true value tag, and the importance of the sample data in which some tags are missing is represented through the weight. In this way, when the loss value of the model is calculated, a loss value of a missing tag of the sample can be calculated with reference to the weight in the case of retaining the sample data in which some tags are missing, which effectively solves the problem that prediction accuracy is reduced due to the deletion of samples in the data set in which some tags are missing, improves the accuracy of the model, and accurately predicts the predicted values of a plurality of dimensions at the same time.

The above description is only an overview of the technical solution of the present disclosure. In order to understand the technical means of the present disclosure more clearly, the technical means can be implemented according to the content of the specification, and in order to make the above and other purposes, features and advantages of the present disclosure more obvious and understandable, a specific embodiment of the present disclosure is specifically taken as an example.

### BRIEF DESCRIPTION OF THE DRAWINGS

The accompanying drawings described herein are provided to provide a further understanding of the present disclosure and constitute a part of the present disclosure. The illustrative embodiments of the present disclosure and their descriptions are used to explain the present disclosure and do not constitute undue limitations on the present disclosure. In the accompanying drawings:

FIG. 1 shows a flow chart of a model training method according to an embodiment of the present disclosure;

FIG. 2 shows a flow chart of a construction safety evaluation method for a wind power project according to an embodiment of the present disclosure;

FIG. 3 shows a block diagram of a structure of a model training apparatus according to an embodiment of the present disclosure; and

FIG. 4 shows a block diagram of a structure of a construction safety evaluation apparatus for a wind power project according to an embodiment of the present disclosure.

### DETAILED DESCRIPTION OF THE EMBODIMENTS

The present disclosure will be described in detail with reference to the accompanying drawings and embodiments below. It should be noted that the embodiments in the present disclosure and the features in the embodiments can be combined with each other without conflict.

Hereinafter, embodiments of the present disclosure will be described in detail, examples of which are illustrated in the accompanying drawings. The same or similar reference numerals indicate the same or similar elements or elements having the same or similar functions throughout. The embodiments described below with reference to the accompanying drawings are exemplary and are only used to explain the present disclosure, and cannot be interpreted as limitations of the present disclosure.

It can be understood by those skilled in the art that a singular form “a”, “an”, “said” and “the” used herein can further include a plural form unless specifically stated. It should be further understood that the word “including” used in the specification of the present disclosure refers to the presence of the features, integers, steps, operations, elements and/or components, but does not exclude the presence or addition of one or more other features, integers, steps, operations, elements, components and/or a group thereof. It should be understood that when an element is “connected” or “linked” to another element, the element can be directly connected or linked to another element, or intervening elements may exist. In addition, “connected” or “linked” as used herein may include wireless connection or wireless attachment. As used herein, the phrase “and/or” as used herein includes all or any unit and all combinations of one or more associated listed items.

Now, exemplary embodiments according to the present disclosure will be described in more detail with reference to the accompanying drawings. However, these exemplary embodiments may be embodied in many different forms and should not be construed as limited to the embodiments set forth herein. It should be understood that these embodiments are provided so that the content of the present disclosure will be thorough and complete, and the concepts of these exemplary embodiments are fully conveyed to those skilled in the art.

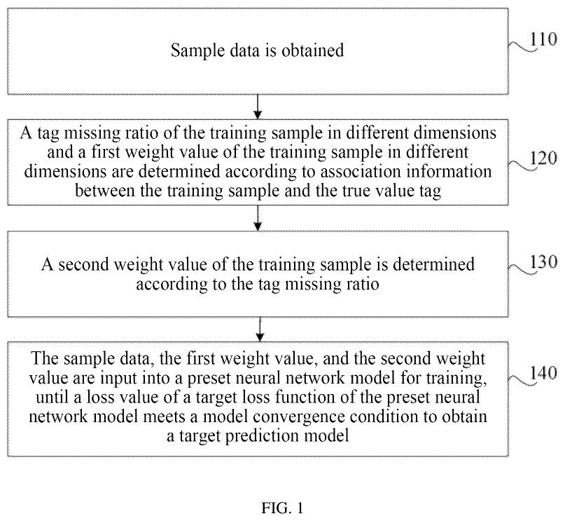

In this embodiment, a model training method is provided. As shown in FIG. 1, the method includes:

Step 110, sample data is obtained.

The sample data includes a training sample and a true value tag of the training sample in different dimensions, that is, different true value tags can be associated with the same training sample in different dimensions. Specifically, the sample data can be expressed in a matrix format, such as the training sample

$$X = ⌊ {x}_{1}^{{d}_{1}} , {x}_{2} ⋯ , {x}_{n}^{dn} ⌋ ∈ {R}^{n \times d} ,$$

and the true value tag Y=[y₁, y₂, . . . yₙ]^{T}∈R^{n×l}, where xᵢ∈R^{d} is an i-th sample, dis a feature dimension, n is the total number of samples, and/is the number of tags to be predicted.

Step 120, a tag missing ratio of the training sample in different dimensions and a first weight value of the training sample in different dimensions are determined according to association information between the training sample and the true value tag.

In this embodiment, the tag loss ratio characterizing the tag loss of different training samples in each feature dimension and the first weight value characterizing whether there is a true value tag loss in each training sample in a certain feature dimension are determined through the association information indicating whether the training sample is associated with the true value tag, so that the reference importance of each training sample is accurately evaluated through the tag missing ratio and the first weight value, the weighted loss is calculated, and the trained target prediction model can better meet the accuracy requirement of the practical scenario.

In a specific embodiment, in Step 120, determining a first weight value of the training sample in different dimensions according to association information between the training sample and the true value tag specifically includes the following steps:
if the association information is that the training sample is associated with the true value tag in any dimension, assigning a value of 1 to the first weight value in any dimension; and
if the association information is that the training sample is not associated with the true value tag in any dimension, assigning a value of 0 to the first weight value in any dimension.

In this embodiment, a value of 1 or 0 is assigned to the first weight value correspondingly according to whether the training sample is associated with a true value tag, so as to better distinguish the training sample with a true value tag from the training sample without a true value tag. When the training sample has a true value tag in a certain dimension, a value of 1 is assigned to the first weight value in the dimension, which indicates that the training sample in the dimension has a positive effect on the training of the model. On the contrary, when the training sample has no true value tag in a certain dimension, a value of 0 is assigned to the first weight value in the dimension, which indicates that the training sample in the dimension has no effect on the training of the model. In this way, when the model is trained, even if the training sample lacks a tag in a certain dimension, the training sample may be retained, so that the model can learn the features of the training sample in other dimensions. Therefore, the learning ability and the generalization ability of data are improved when the model is trained, which helps to enhance the ability of the model of processing the data with missing tags.

For example, if the element in the i-th row and the j-th column of the true value tag matrix Y is missing, the first weight value aᵢⱼ is denoted as 0, otherwise, it is denoted as 1.

In a specific embodiment, in Step 120, determining a tag missing ratio of the training sample in different dimensions according to association information between the training sample and the true value tag specifically includes the following steps:
counting the number of missing tags of the training sample in which the association information is that the training sample is not associated with the true value tag in any dimension; and
calculating the quotient of the number of missing tags in the dimension and the total number of training samples in the sample data as the tag missing ratio in any dimension.

In this embodiment, the quotient of the number of missing tags in each dimension and the total number of training samples in the dimension in the sample data in the dimension can be calculated, and the tag missing ratio of each dimension can be obtained. The tag missing ratio reflects the degree of tag missing in each dimension, thereby facilitating subsequent processing and weight adjustment when the neural network model is trained, and improving the accuracy and the generalization ability of the model.

For example, taking 5 training samples and 3 feature dimensions as examples, the sample data matrix is expressed as:

$$[ \begin{matrix}{x}_{1} & {y}_{11} & {y}_{12} & {y}_{13} \\ ⋮ & & ⋱ & ⋮ \\ {x}_{5} & {y}_{51} & {y}_{52} & {y}_{53}\end{matrix} ] .$$

If only the true value tag y₁₂ is empty, it indicates that the true value tag is missing in the second feature dimension of the training sample x₁, and the tag missing ratio for the second feature dimension is ⅕. If the true value tags y₁₂ and y₃₂ are empty, it indicates that the true value tags are missing in the second feature dimension of the training sample x₁ and x₃, and the tag missing ratio for the second feature dimension is ⅖. The greater the tag missing ratio, the more serious the tag missing in the corresponding dimension.

Step 130, a second weight value of the training sample is determined according to the tag missing ratio.

In this embodiment, the second weight value when the neural network model is trained is dynamically adjusted according to the degree of tag missing in each dimension, so that the ability of the model of processing the data with missing tags can be further enhanced, and the accuracy and robustness of the model can be improved.

In a specific embodiment, Step 130, that is, determining the second weight value of the training sample according to the tag missing ratio, specifically includes the following steps.

An information entropy and mutual information of the true value tag are calculated.

The entropy is an indicator of the information content. The higher the entropy, the greater the information content, the higher the uncertainty, and the more difficult it is to predict. The mutual information is the statistic used to measure the close relationship between two true value tags, which shows the correlation between true value tags. The higher the information entropy, the lower the reliability of tag data. The greater the mutual information, the higher the correlation between tags.

Specifically, the formula for calculating the information entropy of the true value tag is expressed as:

$${E}_{j} = - {\sum }_{i = 1}^{n} {p}_{ij} {log}_{2} {p}_{ij} ;$$

where Eⱼ denotes the information entropy of the j-th true value tag, pᵢⱼ denotes the probability that the value of the i-th training sample appears on the j-th true value tag, and n denotes the total number of training samples.

The formula for calculating the mutual information of the true value tag is expressed as:

$$I ( {Y}_{j} ; {Y}_{k} ) = {\sum }_{i = 1}^{n} {\sum }_{{y}_{j} , {y}_{k}} p ( {y}_{j} , {y}_{k} ) {log}_{2} \frac{p ( {y}_{j} , {y}_{k} )}{p ( {y}_{j} ) , p ( {y}_{k} )} ;$$

where I(Yⱼ;Yₖ) denotes the mutual information between tags Yⱼ and Yₖ, p(yⱼ,yₖ) denotes a joint probability quality function of tags Yⱼ and Yₖ, and p(yⱼ) and p(yₖ) denote marginal probability quality functions of tags Yⱼ and Yₖ, respectively.

The second weight value is determined according to the information entropy, the mutual information, and the tag missing ratio.

Specifically, the second weight value is determined according to the information entropy, the mutual information, and the tag missing ratio using the following formula:

$${w}_{j} = \frac{1 - {E}_{j}}{{\sum }_{k - 1}^{m} ( 1 - {E}_{k} )} \times \frac{{\sum }_{k - 1}^{m} I ( {Y}_{j} ; {Y}_{k} )}{max {\sum }_{l - 1}^{m} I ( {Y}_{k} ; {Y}_{l} )} \times ( 1 - α ) ;$$

where wⱼ denotes a second weight value of the j-th truth value tag, m denotes the total number of truth value tags in any dimension, Eⱼ denotes the information entropy of the j-th truth value tag, Eₖ denotes the information entropy of the k-th truth value tag, I(Yⱼ;Yₖ) denotes the mutual information between tags Yⱼ and Yₖ, I(Yₖ; Yₗ) denotes the mutual information between tags Yₖ and Yₗ, and α denotes a tag missing ratio in any dimension.

In this embodiment, an entropy weight method is used to calculate the information entropy and the mutual information of each true value tag. The uncertainty of tags and the correlation between tags are measured by calculating the information entropy and the mutual information of the true value tag, and then different tags are comprehensively weighted in combination with the tag missing ratio to obtain the second weight value, so as to distribute the weights based on the information entropy, and further adjust the weights by using the mutual information and the tag missing ratio. In this way, the tags with higher correlation with other true value tags or lower missing ratio obtain higher weights. Furthermore, the second weight value is reasonably determined, so that the model learns the potential distribution of missing data and the correlation between the data, reduce the over-fitting risk and the influence of tag missing on the model performance, and at the same time, reduce the subjective dependence of sample data. In this way, the weights are distributed more objectively and reasonably, and the balance of the importance of each tag in different dimensions is ensured. The generalization ability of the model is further improved, so that the model can achieve a good prediction effect on different data sets, and the performance and the stability of the target prediction model are improved.

It is worth mentioning that a generative adversarial network can also be constructed using the true value tags, the information entropy and the mutual information, so that the generative adversarial network can learn the potential distribution of missing tags. The trained generative adversarial network is used to generate reconstructed tags meeting the distribution law of the true value tags, and the reconstructed tags are filled in the tag missing positions of the corresponding training samples, so that the data features are learned from irregular discrete measurement data using the generative adversarial network in an unsupervised manner. In this way, the sample data needed for training is more complete, and it is ensured that high data accuracy can be maintained at different missing ratios.

Specifically, the generative adversarial network can be a Convolutional Neural Network (CNN) or a Vision Transformer (ViT).

In an embodiment, after Step 130, the model training method further includes normalizing the second weight value.

In this embodiment, the second weight value is linearly transformed by normalization, and is mapped to the range of [0,1]. Moreover, the sum of the second weight values of all true value tags in the same dimension is 1. Therefore, the influence of the correlation between different true value tags on the training quality of the model can be better balanced, and the model is more interpretable and stable in the training process.

Step 140, the sample data, the first weight value, and the second weight value are input into a preset neural network model for training, until a loss value of a target loss function of the preset neural network model meets a model convergence condition to obtain a target prediction model.

Specifically, the preset neural network model can use a monolithic neural network model, for example, a Deep Neural Networks (DNN) model, a Convolutional Neural Network (CNN) model, a Recurrent Neural Network (RNN) model, a Residual Network (ResNet) model, and a BERT (Bidirectional Encoder Representation from Transformer, which is a deep bidirectional self-attention network) model.

According to the model training method provided by the embodiment of the present disclosure, the weight of the training sample in different dimensions is calculated based on the association information indicating whether the training sample is associated with the true value tag, and the importance of the sample data in which some tags are missing is represented through the weight. In this way, when the loss value of the model is calculated, a loss value of a missing tag of the sample can be calculated with reference to the weight in the case of retaining the sample data in which some tags are missing, which effectively solves the problem that prediction accuracy is reduced due to the deletion of samples in the data set in which some tags are missing, and improves the accuracy of the model. In addition, because the sample data is divided according to dimensions, after training the target prediction model using the sample data, the predicted values of a plurality of dimensions can be accurately predicted at the same time, which helps to improve the prediction efficiency.

In the practical application scenario, the target loss function is expressed as:

$$loss ( y , \hat{y} ) = \frac{1}{n} {\sum }_{i = 1}^{n} {\sum }_{j = 1}^{l} {{w}_{j} [ {a}_{ij} ( {\hat{y}}_{j}^{i} - {y}_{j}^{i} ) ]}^{2} ;$$

where loss denotes a loss function, y denotes a true value tag, ŷ denotes a predicted value output by the model, n denotes the total number of training samples, l denotes the number of predicted tags, i denotes the training sample number, j denotes the true value tag number, aᵢⱼ denotes a first weight value of the j-th true value tag of the i-th training sample, and wⱼ denotes a second weight value of the j-th true value tag.

The first weight value indicating whether the tag is missing and the second missing value indicating the correlation degree are introduced into the loss function. In this way, when the loss is calculated, the loss with the missing tag of the sample is not calculated, and the loss is weighted according to the correlation, so that the model pays more attention to the training samples without missing tags and the training samples with higher tag correlation in the training process. Even if there are some missing tags, the data features and distribution in different dimensions can be understood and adapted, so that the training effect of the target prediction model is similar to that of the model without missing samples, and the accuracy and reliability are improved while ensuring the generalization ability of the target language model.

Specifically, for example, the sample data in the data set is analyzed, and the tag missing ratio is calculated. Then the sample data is divided into a training set and a test set according to the preset proportion. The data of the test set is imported into the deep neural network model of the self-defined model loss function for training. Finally, a mean square error is used as an error value between the predicted output and the expected output of the loss function. Furthermore, the model accuracy is evaluated on the verification set, and the parameters of the deep neural network model and the weight of the self-defined loss function are adjusted and optimized, until the loss function is minimized.

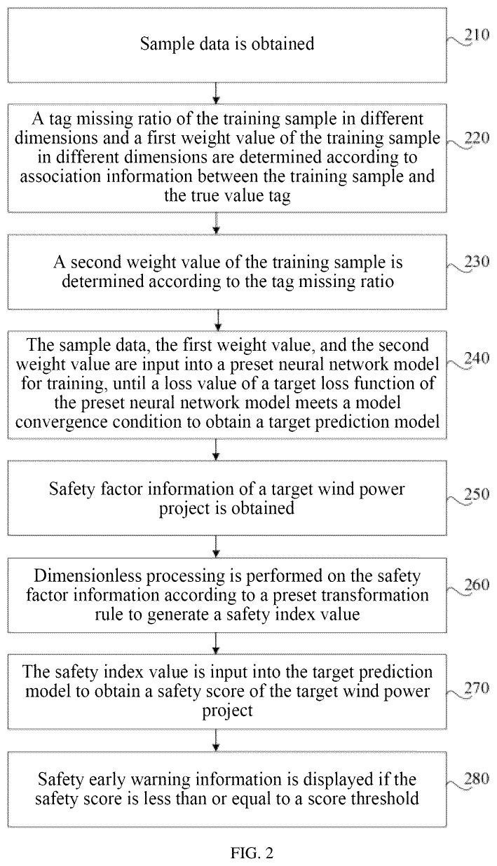

In this embodiment, a construction safety evaluation method for a wind power project is provided, as shown in FIG. 2. The method includes the following steps.

Step 210, sample data is obtained.

The sample data includes safety factor information and a safety score of historical wind power project. The safety factor information includes index values corresponding to different safety factors. Safety factors may be set reasonably according to the actual engineering requirements of the wind power project. For example, the safety factors may include the power and running time of a wind turbine generator system, the remaining validity period and the number of overhauls of an electrical device such as a transmission line, a transformer, and a switchgear, environmental parameters, the deployment of fire prevention facilities, and the like, which will not be described one by one again in the embodiment of the present disclosure.

Step 220, a tag missing ratio of the training sample in different dimensions and a first weight value of the training sample in different dimensions are determined according to association information between the training sample and the true value tag.

In a specific embodiment, in Step 220, determining a first weight value of the training sample in different dimensions according to association information between the training sample and the true value tag specifically includes the following steps: if the association information is that the training sample is associated with the true value tag in any dimension, assigning a value of 1 to the first weight value in any dimension; and if the association information is that the training sample is not associated with the true value tag in any dimension, assigning a value of 0 to the first weight value in any dimension.

In this embodiment, a value of 1 or 0 is assigned to the first weight value correspondingly according to whether the training sample is associated with a true value tag, so as to better distinguish the training sample with a true value tag from the training sample without a true value tag. When the training sample has a true value tag in a certain dimension, a value of 1 is assigned to the first weight value in the dimension, which indicates that the training sample in the dimension has a positive effect on the training of the model. On the contrary, when the training sample has no true value tag in a certain dimension, a value of 0 is assigned to the first weight value in the dimension, which indicates that the training sample in the dimension has no effect on the training of the model. Therefore, the learning ability and the generalization ability of data are improved when the model is trained, which helps to enhance the ability of the model of processing the data with missing tags.

In a specific embodiment, in Step 220, determining a tag missing ratio of the training sample in different dimensions according to association information between the training sample and the true value tag specifically includes the following steps: counting the number of missing tags of the training sample in which the association information is that the training sample is not associated with the true value tag in any dimension; and calculating the quotient of the number of missing tags in the dimension and the total number of training samples in the sample data as the tag missing ratio in any dimension.

In this embodiment, the quotient of the number of missing tags in each dimension and the total number of training samples in the dimension in the sample data in the dimension can be calculated, and the tag missing ratio of each dimension can be obtained. The tag missing ratio reflects the degree of tag missing in each dimension, thereby facilitating subsequent processing and weight adjustment when the neural network model is trained, and improving the accuracy and the generalization ability of the model.

Step 230, a second weight value of the training sample is determined according to the tag missing ratio.

In a specific embodiment, in Step 230, that is, determining a second weight value of the training sample according to the tag missing ratio specifically includes the following steps: calculating an information entropy and mutual information of the true value tag; and determining the second weight value according to the information entropy, the mutual information, and the tag missing ratio.

Specifically, the formula for calculating the information entropy of the true value tag is expressed as:

$${E}_{j} = - {\sum }_{i = 1}^{n} {p}_{ij} {log}_{2} {p}_{ij} ;$$

where Eⱼ denotes the information entropy of the j-th true value tag, pᵢⱼ denotes the probability that the value of the i-th training sample appears on the j-th true value tag, and n denotes the total number of training samples.

The formula for calculating the mutual information of the true value tag is expressed as:

$$I ( {Y}_{j} ; {Y}_{k} ) = {\sum }_{i = 1}^{n} {\sum }_{{y}_{j} , {y}_{k}}^{} p ( {y}_{j} , {y}_{k} ) {log}_{2} \frac{p ( {y}_{j} , {y}_{k} )}{p ( {y}_{j} ) p ( {y}_{k} )} ;$$

where I(Yⱼ;Yₖ) denotes the mutual information between tags Yⱼ and Yₖ, p(yⱼ,yₖ) denotes a joint probability quality function of tags Yⱼ and Yₖ, and p(yⱼ) and p(yₖ) denote marginal probability quality functions of tags Yⱼ and Yₖ, respectively.

The second weight value is determined according to the information entropy, the mutual information, and the tag missing ratio using the following formula:

$${w}_{j} = \frac{1 - {E}_{j}}{{\sum }_{k - 1}^{m} ( 1 - {E}_{k} )} \times \frac{{\sum }_{k - 1}^{m} I ( {Y}_{j} ; {Y}_{k} )}{max {\sum }_{l - 1}^{m} I ( {Y}_{k} ; {Y}_{l} )} \times ( 1 - α ) ;$$

where wⱼ denotes a second weight value of the j-th truth value tag, m denotes the total number of truth value tags in any dimension, Eⱼ denotes the information entropy of the j-th truth value tag, Eₖ denotes the information entropy of the k-th truth value tag, I(Yⱼ;Yₖ) denotes the mutual information between tags Yⱼ and Yₖ, I(Yₖ; Yₗ) denotes the mutual information between tags Yₖ and Yₗ, and α denotes a tag missing ratio in any dimension.

In this embodiment, an entropy weight method is used to calculate the information entropy and the mutual information of each true value tag. The uncertainty of tags and the correlation between tags are measured by calculating the information entropy and the mutual information of the true value tag, and then different tags are comprehensively weighted in combination with the tag missing ratio to obtain the second weight value, so as to distribute the weights based on the information entropy, and further adjust the weights by using the mutual information and the tag missing ratio. In this way, the tags with higher correlation with other true value tags or lower missing ratio obtain higher weights. Furthermore, the second weight value is reasonably determined, so that the model learns the potential distribution of missing data and the correlation between the data, reduce the over-fitting risk and the influence of tag missing on the model performance, and at the same time, reduce the subjective dependence of sample data. In this way, the weights are distributed more objectively and reasonably, and the balance of the importance of each tag in different dimensions is ensured. The generalization ability of the model is further improved, so that the model can achieve a good prediction effect on different data sets, and the performance and the stability of the target prediction model are improved.

Step 240, the sample data, the first weight value, and the second weight value are input into a preset neural network model for training, until a loss value of a target loss function of the preset neural network model meets a model convergence condition to obtain a target prediction model.

The target loss function is expressed as:

$$loss ( y , \hat{y} ) = \frac{1}{n} {\sum }_{i = 1}^{n} {\sum }_{j = 1}^{l} {{w}_{j} [ {a}_{ij} ( {\hat{y}}_{j}^{i} - {y}_{j}^{i} ) ]}^{2} ;$$

where loss denotes a loss function, y denotes a true value tag, ŷ denotes a predicted value output by the model, n denotes the total number of training samples, l denotes the number of predicted tags, i denotes the training sample number, j denotes the true value tag number, aᵢⱼ denotes a first weight value of the j-th true value tag of the i-th training sample, and wⱼ denotes a second weight value of the j-th true value tag.

Step 250, safety factor information of a target wind power project is obtained.

Step 260, dimensionless processing is performed on the safety factor information according to a preset transformation rule to generate a safety index value.

In this embodiment, the complex safety factor information can be transformed into a unified and concise indicator, which facilitates the model to perform comparison and analysis and improves the data processing efficiency.

Step 270, the safety index value is input into the target prediction model to obtain a safety score of the target wind power project.

Step 280, safety early warning information is displayed if the safety score is less than or equal to a score threshold.

The score threshold can be set reasonably according to the safety requirements of the project, which is not specifically limited in the embodiment of the present disclosure.

The construction safety evaluation method for the wind power project provided by the embodiment of the present disclosure takes the safety factor information and the safety score of the historical wind power project as samples, and trains the target prediction model in combination with the first weight value and the second weight value relevant to whether the safety score is missing. Through the trained target prediction model, the safety of the target wind power project is scored. Moreover, when the safety score is low, the system automatically prompts the user for safety issues. Even if some sample data are missing, the operation safety of the wind power project can be accurately predicted, thereby effectively solving the problems that it is difficult to process the data in the safety field due to high complexity and the prediction accuracy of the network model is not high, improving the effectiveness of safety prediction, and ensuring the safe construction and maintenance of the wind power project.

The model training method and the construction safety evaluation method for the wind power project provided by the embodiment of the present disclosure can be applied to a terminal, a server, or the software operating in the terminal or the server. In some embodiments, the terminal can be a smart phone, a tablet computer, a notebook computer, a desktop computer, and the like. The server can be configured as an independent physical server, a server cluster or a distributed system formed by a plurality of physical servers, or a cloud server that provides basic cloud computing services such as a cloud service, a cloud database, cloud computing, a cloud function, cloud storage, a network service, cloud communication, a middleware service, a domain name service, a security service, a Content Delivery Network (CDN), big data, and an artificial intelligence platform. The software can be an application for implementing the intention recognition method, but is not limited to the above forms.

It should be noted that the sequence number of each step in the foregoing embodiment does not mean the order of execution. The order of execution of each process should be determined by the function and the internal logic, and should not constitute any limitation on the implementation process of the embodiment of the present disclosure.

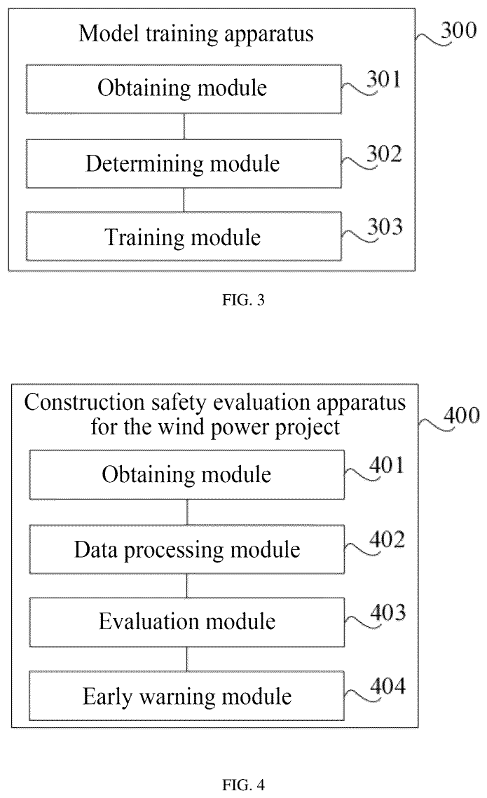

Further, as shown in FIG. 3, as a specific implementation of the foregoing model training method, the embodiment of the present disclosure provides a model training apparatus 300. The model training apparatus 300 includes an obtaining module 301, a determining module 302, and a training module 303.

The obtaining module 301 is configured to obtain sample data, where the sample data includes a training sample and a true value tag of the training sample in different dimensions.

The determining module 302 is configured to determine a tag missing ratio of the training sample in different dimensions and a first weight value of the training sample in different dimensions according to association information between the training sample and the true value tag; and determine a second weight value of the training sample according to the tag missing ratio.

The training module 303 is configured to input the sample data, the first weight value, and the second weight value into a preset neural network model for training, until a loss value of a target loss function of the preset neural network model meets a model convergence condition to obtain a target prediction model.

In this embodiment, the weight of the training sample in different dimensions is calculated based on the association information indicating whether the training sample is associated with the true value tag, and the importance of the sample data in which some tags are missing is represented through the weight. In this way, when the loss value of the model is calculated, a loss value of a missing tag of the sample can be calculated with reference to the weight in the case of retaining the sample data in which some tags are missing, which effectively solves the problem that prediction accuracy is reduced due to the deletion of samples in the data set in which some tags are missing, improves the accuracy of the model, and accurately predicts the predicted values of a plurality of dimensions at the same time.

Further, the determining module 302 is specifically configured to, if the association information is that the training sample is associated with the true value tag in any dimension, assign a value of 1 to the first weight value in any dimension; and if the association information is that the training sample is not associated with the true value tag in any dimension, assign a value of 0 to the first weight value in any dimension.

Further, the determining module 302 is specifically configured to count the number of missing tags of the training sample in which the association information is that the training sample is not associated with the true value tag in any dimension; and calculate the quotient of the number of missing tags in the dimension and the total number of training samples in the sample data as the tag missing ratio in any dimension.

Further, the determining module 302 is specifically configured to calculate an information entropy and mutual information of the true value tag; and determine the second weight value according to the information entropy, the mutual information, and the tag missing ratio.

Further, the model training apparatus 300 further includes a preprocessing module (not shown in the figure).

The preprocessing module is configured to normalize the second weight value.

Further, as shown in FIG. 4, as a specific implementation of the construction safety evaluation method for the wind power project, the embodiment of the present disclosure provides a construction safety evaluation apparatus for a wind power project 400. The construction safety evaluation apparatus for the wind power project 400 includes an obtaining module 401, a data processing module 402, an evaluation module 403, and an early warning module 404.

The obtaining module 401 is configured to obtain a target prediction model and safety factor information of a target wind power project, where the target prediction model takes safety factor information and a safety score of a historical wind power project as sample data and is trained by the model training method provided in the embodiment of the first aspect.

The data processing module 402 is configured to perform dimensionless processing on the safety factor information according to a preset transformation rule to generate a safety index value.

The evaluation module 403 is configured to input the safety index value into the target prediction model to obtain a safety score of the target wind power project.

The early warning module 404 is configured to display safety early warning information if the safety score is less than or equal to a score threshold.

In this embodiment, the safety factor information and the safety score of the historical wind power project are taken as samples, and the target prediction model is trained in combination with the first weight value and the second weight value relevant to whether the safety score is missing. Through the trained target prediction model, the safety of the target wind power project is scored. Moreover, when the safety score is low, the system automatically prompts the user for safety issues. Even if some sample data are missing, the operation safety of the wind power project can be accurately predicted, thereby effectively solving the problems that it is difficult to process the data in the safety field due to high complexity and the prediction accuracy of the network model is not high, improving the effectiveness of safety prediction, and ensuring the safe construction and maintenance of the wind power project.

For the specific limitation of the model training apparatus, refer to the limitation of the model training method above, which will not be described in detail here. Each module in the above model training apparatus can be achieved in whole or in part by software, hardware and the combination thereof. The above modules can be embedded in or independent of the processor in the computer device in the form of hardware, and can also be stored in the memory in the computer device in the form of software, so that the processor can call and execute the operations corresponding to the above modules.

Based on the above methods as shown in FIG. 1 and FIG. 2, correspondingly, the embodiment of the present disclosure further provides a readable storage medium, on which a computer program is stored. The program, when executed by a processor, implements the model training method as shown in FIG. 1 and the construction safety evaluation method for the wind power project as shown in FIG. 2.

Based on this understanding, the technical solution of the present disclosure can be embodied in the form of a software product. The software product can be stored in a non-volatile storage medium (which may be a Compact Disc Read-Only Memory (CD-ROM), a Universal Serial Bus (USB) flash drive, a mobile hard disk, and the like), including several instructions to allow a computer device (which may be a personal computer, a server, or a network device, and the like) to execute the methods described in various implementation scenarios of the present disclosure.

Based on the methods shown in FIG. 1 and FIG. 2 and the virtual device embodiments shown in FIG. 3 and FIG. 4, in order to achieve the above purpose, the embodiment of the present disclosure further provides a computer device, which may be specifically a personal computer, a server, a network device, and the like. The computer device includes a storage medium and a processor. The storage medium is configured to store a computer program. The processor is configured to execute a computer program to implement the model training method shown in FIG. 1 and the construction safety evaluation method for the wind power project shown in FIG. 2.

Preferably, the computer device may further include a user interface, a network interface, a camera, a Radio Frequency (RF) circuit, a sensor, an audio circuit, a WI-FI module, and the like. The user interface may include a display, an input unit such as a keyboard, and the like. Preferably, the user interface may further include a USB interface, a card reader interface, and the like. Preferably, the network interface can include a standard wired interface, a wireless interface (such as a Bluetooth interface, a WI-FI interface), and the like.

It can be understood by those skilled in the art that a structure of a computer device provided by this embodiment does not constitute a limitation on the computer device, and may include more or less components, or combine some components, or have different component arrangements.

The storage medium may further include an operating system and a network communication module. The operating system is a program that manages and stores hardware and software resources of the computer device, and supports the operation of the information processing program and other software and/or programs. The network communication module is configured to achieve the communication between the components in the storage medium and the communication with other hardware and software in the entity device.

Through the description of the above embodiments, those skilled in the art can clearly understand that the present disclosure can be implemented in a manner of software plus a necessary general hardware platform or by hardware.

Those skilled in the art can understand that the accompanying drawing is only a schematic diagram of a preferred implementation scenario, and the modules or processes in the accompanying drawing are not necessarily essential for implementing the present disclosure. Those skilled in the art can understand that the modules in the apparatuses in the implementation scenario can be distributed in the apparatuses in the implementation scenario according to the description of the implementation scenario, and can also be located in one or more apparatuses different from the implementation scenario with corresponding changes. The modules of the forgoing implementation scenario may be merged into one module or further split into a plurality of sub-modules.

The foregoing serial number of the present disclosure is only for description, and does not represent the advantages and disadvantages of the implementation scenario. Only a few specific implementation scenarios of the present disclosure are disclosed above, but the present disclosure is not limited thereto. Any changes conceivable to those skilled in the art should fall within the scope of protection of the present disclosure.

What is claimed is:

1. A model training method, comprising:
obtaining sample data, wherein the sample data comprises a training sample and a true value tag of the training sample in different dimensions, the training sample comprises safety factor information of a historical wind power project, and the true value tag comprises a safety score of the historical wind power project;
determining a tag missing ratio of the training sample in different dimensions and a first weight value of the training sample in different dimensions according to association information between the training sample and the true value tag;
determining a second weight value of the training sample according to the tag missing ratio; and
inputting the sample data, the first weight value, and the second weight value into a preset neural network model for training, until a loss value of a target loss function of the preset neural network model meets a model convergence condition to obtain a target prediction model, wherein the target prediction model is configured to predict a safety score of a target wind power project;
wherein determining a tag missing ratio of the training sample in different dimensions and a first weight value of the training sample in different dimensions according to association information between the training sample and the true value tag comprises:
if the association information is that the training sample is associated with the true value tag in any dimension, assigning a value of 1 to the first weight value in any dimension; if the association information is that the training sample is not associated with the true value tag in any dimension, assigning a value of 0 to the first weight value in any dimension; counting the number of missing tags of the training sample in which the association information is that the training sample is not associated with the true value tag in any dimension; and calculating the quotient of the number of missing tags in the dimension and the total number of training samples in the sample data as the tag missing ratio in any dimension;
determining a second weight value of the training sample according to the tag missing ratio comprises:
calculating an information entropy and mutual information of the true value tag; and determining the second weight value according to the information entropy, the mutual information, and the tag missing ratio;
the target loss function being expressed as:
$$loss ( y , \hat{y} ) = \frac{1}{n} {\sum }_{i = 1}^{n} {\sum }_{j = 1}^{l} {{w}_{j} [ {a}_{ij} ( {\hat{y}}_{j}^{i} - {y}_{j}^{i} ) ]}^{2} ;$$
wherein loss denotes a loss function, y denotes a true value tag, ŷ denotes a predicted value output by the model, n denotes the total number of training samples, l denotes the number of predicted tags, i denotes the training sample number, aᵢⱼ denotes a first weight value of the j-th true value tag of the i-th training sample, and wⱼ denotes a second weight value of the j-th true value tag.

2. The model training method according to claim 1, wherein
the formula for calculating the information entropy of the true value tag is expressed as:
$${E}_{j} = - {\sum }_{i = 1}^{n} {p}_{ij} {log}_{2} {p}_{ij} ;$$
wherein Eⱼ denotes the information entropy of the j-th true value tag, pᵢⱼ denotes the probability that the value of the i-th training sample appears on the j-th true value tag, and n denotes the total number of training samples;
the formula for calculating the mutual information of the true value tag is expressed as:
$$I ( {Y}_{j} ; {Y}_{k} ) = {\sum }_{i = 1}^{n} {\sum }_{{y}_{j} , {y}_{k}}^{} p ( {y}_{j} , {y}_{k} ) {log}_{2} \frac{p ( {y}_{j} , {y}_{k} )}{p ( {y}_{j} ) p ( {y}_{k} )} ;$$
wherein I(Yⱼ;Yₖ) denotes the mutual information between tags Yⱼ and Yₖ, p(yⱼ,yₖ) denotes a joint probability quality function of tags Yⱼ and Yₖ, and p(yⱼ) and p(yₖ) denote marginal probability quality functions of tags Yⱼ and Yₖ, respectively;
the second weight value is determined according to the information entropy, the mutual information, and the tag missing ratio using the following formula:
$${w}_{j} = \frac{1 - {E}_{j}}{{\sum }_{k - 1}^{m} ( 1 - {E}_{k} )} \times \frac{{\sum }_{k - 1}^{m} I ( {Y}_{j} ; {Y}_{k} )}{max {\sum }_{l - 1}^{m} I ( {Y}_{k} ; {Y}_{l} )} \times ( 1 - α ) ;$$
wherein wⱼ denotes a second weight value of the j-th truth value tag, m denotes the total number of truth value tags in any dimension, Eⱼ denotes the information entropy of the j-th truth value tag, I(Yⱼ;Yₖ) denotes the mutual information between tags Yⱼ and Yₖ, I(Yₖ; Yₗ) denotes the mutual information between tags Yₖ and Yₗ, and α denotes a tag missing ratio in any dimension.

3. The model training method according to claim 1, further comprising:
normalizing the second weight value.

4. A construction safety evaluation method for a wind power project, comprising:
obtaining a target prediction model and safety factor information of a target wind power project, wherein the target prediction model takes safety factor information and a safety score of a historical wind power project as sample data and is trained by the model training method according to claim 1;
performing dimensionless processing on the safety factor information of the target wind power project according to a preset transformation rule to generate a safety index value;
inputting the safety index value into the target prediction model to obtain a safety score of the target wind power project; and
displaying safety early warning information if the safety score is less than or equal to a score threshold.

5. A model training apparatus, wherein the apparatus comprises:
an obtaining module, which is configured to obtain sample data, wherein the sample data comprises a training sample and a true value tag of the training sample in different dimensions, the training sample comprises safety factor information of a historical wind power project, and the true value tag comprises a safety score of the historical wind power project;
a determining module, which is configured to determine a tag missing ratio of the training sample in different dimensions and a first weight value of the training sample in different dimensions according to association information between the training sample and the true value tag; and configured to determine a second weight value of the training sample according to the tag missing ratio; and
a training module, which is configured to input the sample data, the first weight value, and the second weight value into a preset neural network model for training, until a loss value of a target loss function of the preset neural network model meets a model convergence condition to obtain a target prediction model, wherein the target prediction model is configured to predict a safety score of a target wind power project;
wherein the determining module is configured to, if the association information is that the training sample is associated with the true value tag in any dimension, assign a value of 1 to the first weight value in any dimension; if the association information is that the training sample is not associated with the true value tag in any dimension, assign a value of 0 to the first weight value in any dimension; count the number of missing tags of the training sample in which the association information is that the training sample is not associated with the true value tag in any dimension; and calculate the quotient of the number of missing tags in the dimension and the total number of training samples in the sample data as the tag missing ratio in any dimension; calculate an information entropy and mutual information of the true value tag; and determine the second weight value according to the information entropy, the mutual information, and the tag missing ratio;
the target loss function is expressed as:
$$loss ( y , \hat{y} ) = \frac{1}{n} {\sum }_{i = 1}^{n} {\sum }_{j = 1}^{l} {{w}_{j} [ {a}_{ij} ( {\hat{y}}_{j}^{i} - {y}_{j}^{i} ) ]}^{2} ;$$
wherein loss denotes a loss function, y denotes a true value tag, ŷ denotes a predicted value output by the model, n denotes the total number of training samples, l denotes the number of predicted tags, i denotes the training sample number, aᵢⱼ denotes a first weight value of the j-th true value tag of the i-th training sample, and wⱼ denotes a second weight value of the j-th true value tag.

6. A construction safety evaluation apparatus for a wind power project, comprising:
an obtaining module, which is configured to obtain a target prediction model and safety factor information of a target wind power project, wherein the target prediction model takes safety factor information and a safety score of a historical wind power project as sample data and is trained by the model training method according to claim 1;
a data processing module, which is configured to perform dimensionless processing on the safety factor information of the target wind power project according to a preset transformation rule to generate a safety index value;
an evaluation module, which is configured to input the safety index value into the target prediction model to obtain a safety score of the target wind power project; and
an early warning module, which is configured to display safety early warning information if the safety score is less than or equal to a score threshold.

7. A computer device, comprising a storage medium, a processor, and a computer program stored on the storage medium and executable on the processor, wherein the processor, when executing the program, implements the model training method according to claim 1.

8. A computer device, comprising a storage medium, a processor, and a computer program stored on the storage medium and executable on the processor, wherein the processor, when executing the program, implements the model training method according to claim 2.

9. A computer device, comprising a storage medium, a processor, and a computer program stored on the storage medium and executable on the processor, wherein the processor, when executing the program, implements the model training method according to claim 3.

10. A computer device, comprising a storage medium, a processor, and a computer program stored on the storage medium and executable on the processor, wherein the processor, when executing the program, implements the construction safety evaluation method for the wind power project according to claim 4.
